(19) United States
(12) Patent Application Publication
(10) Pub. No.: US 2025/0379897 A1
(43) Pub. Date: Dec. 11, 2025

(54) Screen Composing Method Using Web Conferencing System

(71) Applicant: INTERACTIVE SOLUTIONS CORP., Chiyoda-ku, Tokyo (JP)

(72) Inventor: Kiyoshi SEKINE, Chiyoda-ku, Tokyo (JP)

(73) Assignee: INTERACTIVE SOLUTIONS CORP., Chiyoda-ku, Tokyo (JP)

(21) Appl. No.: 18/877,256

(22) PCT Filed: Jun. 20, 2023
(86) PCT No.: PCT/JP2023/022718

§ 371 Date: Dec. 19, 2024

(30) Foreign Application Priority Data
Jun. 20, 2022 (JP) 2022-099175

(51) Int. Cl. H04L 65/1089; G06V 40/16; H04L 12/18; H04L 65/403

(52) U.S. Cl. CPC H04L 65/1089; G06V 40/171; H04L 12/1822; H04L 12/1831; H04L 65/403

(57) ABSTRACT

[Problem] To provide a screen composing method using a web conferencing system that is capable of extracting and displaying specific participants. [Solution] This screen composing method using a web conferencing system, the screen composing method comprising: a material displaying step of, by the web conference system, displaying a material used for a web conference on a display unit; a participant image receiving step of, by the web conferencing system, receiving a captured image of each of a plurality of participants participating in the web conference; a participant selecting step of, by the web conferencing system, receiving a selection of two or more participants from among the participants whose images have been received in the participant image receiving step; and a selected participant displaying step of, by the web conferencing system, extracting image regions of the participants for the two or more participants selected in the participant selecting step from captured images of the participants and displaying images based on the extracted image regions of the participants together with the material on the display unit, the images based on the image regions of the participants being displayed on the display unit on a basis of a predetermined display pattern in the selected participant displaying step.

### TECHNICAL FIELD

The present invention relates to a screen composing method using a web conferencing system, and the like.

### BACKGROUND ART

JP 7062126 B1 describes a web conferencing system using avatars.

### CITATION LIST

### Patent Literature

Patent Literature 1: JP 7062126 B1

### SUMMARY OF INVENTION

### Technical Problem

An object of the present invention is to provide a screen composing method using a web conferencing system that is capable of extracting and displaying specific participants.

### Solution to Problem

A first invention relates to a screen composing method using a web conferencing system 1. This method includes a material displaying step (S110), a participant image receiving step (S120), a participant selecting step (S130), and a selected participant displaying step (S140).

The material displaying step (S110) is a step of, by the web conferencing system 1, displaying the material used for the web conference on a display unit 3.

The participant image receiving step (S120) is a step of, by the web conferencing system 1, receiving a captured image of each of a plurality of participants participating in the web conference.

The participant selecting step (S130) is a step of, by the web conferencing system 1, receiving the selection of two or more participants from among the participants received in the participant image receiving step.

The selected participant displaying step (S140) is a step of, by the web conferencing system 1, extracting an image region of each of the two or more participants selected in the participant selecting step from a captured image of the participant and displaying images based on the extracted image regions of the participants together with a material on the display unit 3.

In the selected participant displaying step, the images based on the image regions of the participants are displayed on the display unit 3 on the basis of a predetermined display pattern.

A preferable example of this screen composing method further includes a speaker identifying step (S131). The speaker identifying step (S131) is a step of, by the web conferencing system 1, identifying a person who has spoken, out of the participants participating in the web conference. Then, in the participant selecting step (S130), two or more participants are selected from among the participants, using information about identified persons who have spoken.

In a preferable example of this screen composing method, when a first participant and a second participant are determined to have talked with each other, the web conferencing system 1 displays an image based on an image region of the first participant and an image based on an image region of the second participant on the display unit 3 in the selected participant displaying step (S130).

In a preferable example of this screen composing method, when a questioner is determined to have asked a question about an explanation by a presenter, the web conferencing system 1 displays an image based on a video region of the presenter and an image based on a video region of the questioner on the display unit 3 in the selected participant displaying step (S130).

A preferable example of this screen composing method further includes a display image storing step (S150).

The display image storing step (S150) is a step of, by the web conferencing system 1, storing a display image including the material and the images based on the image regions of the participants displayed on the display unit 3 in the selected participant displaying step (S140).

A preferable example of this screen composing method further includes a recorded information revising step (S160).

The recorded information revising step (S160) is a step of revising an image pertaining to the material in the display image stored in the display image storing step (S150) and storing the revised image in a case where the material has been revised.

In an example of the screen composing method, the web conferencing system 1 includes a code information displaying step (S210). The code information displaying step (S210) is a step of displaying code information on the display unit 3. For example, in the code information displaying step (S210), code information corresponding to each page of the material is displayed on the display unit 3. In a preferable example of this step, as the web conference progresses, the web conferencing system 1 updates the code information to obtain updated code information and displays the updated code information on the display unit 3.

The following invention relates to a program and a non-transitory information recording medium that stores the program. This program is a program for causing a computer to execute any one of the screen composing methods described above.

### Advantageous Effects of Invention

It is possible to provide a screen composing method using a web conferencing system that is capable of extracting and displaying specific participants.

### BRIEF DESCRIPTION OF DRAWINGS

FIG. 1 is a flowchart for describing a screen composing method.

FIG. 2 is an overview diagram illustrating a web conferencing system.

FIG. 3 is a block diagram illustrating the web conferencing system.

FIG. 4 is a conceptual diagram illustrating an example in which a material and participant images are displayed on a manager screen.

FIG. 5 is a diagram illustrating how a manager selects a participant.

FIG. 6 is a diagram illustrating an example in which images based on image regions of participants are displayed.

FIG. 7 is a diagram illustrating, differently from the above, the example in which images based on image regions of participants are displayed.

### DESCRIPTION OF EMBODIMENT

An embodiment for practicing the present invention will be described below with reference to the drawings. The present invention is not limited to the embodiment described below but also includes modifications that are made by those skilled in the art as appropriate within a scope obvious to those skilled in the art from the following embodiment.

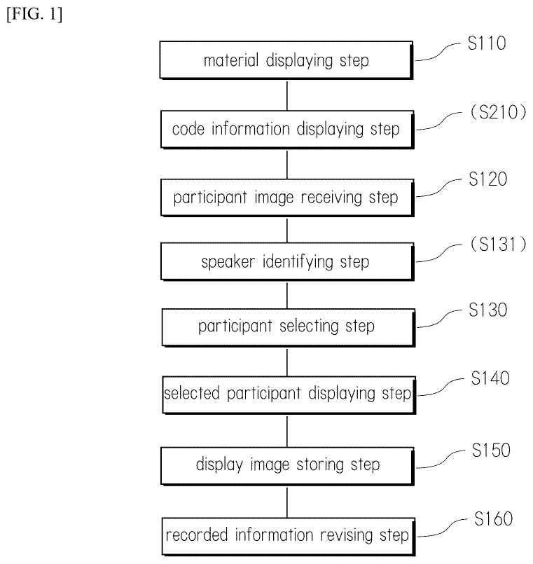

FIG. 1 is a flowchart for describing a screen composing method. As illustrated in FIG. 1, this method includes a material displaying step (S110), a participant image receiving step (S120), a participant selecting step (S130), and a selected participant displaying step (S140). In addition, as illustrated in FIG. 1, this method may further include any one or more of a speaker identifying step (S131), a display image storing step (S150), and a recorded information revising step (S160). Note that the example in FIG. 1 is an example of the steps. The order of the steps may be changed as appropriate, or the steps may be performed simultaneously. For example, the participant image receiving step (S120) may be performed after the material displaying step (S110), or the material displaying step (S110) may be performed after the participant image receiving step (S120). In addition, as illustrated in FIG. 1, this method may include a code information displaying step (S210). Note that this method is not limitative. The code information displaying step (S210) may be configured such that a display image displayed on a display unit can be stored and read. This method is executed by a computer or a processor.

The computer or the processor includes an input unit, an output unit, a control unit, a computation unit, and a storage unit, and the elements are connected together with a bus or the like so as to exchange information with one another. For example, the storage unit may store a program and may store various types of information. When predetermined information is input from the input unit, the control unit reads the program stored in the storage unit. The control unit then reads information stored in the storage unit and transfers the information to the computation unit as appropriate. The control unit also transfers input information to the computation unit as appropriate. The computation unit performs computational processing using various types of received information and stores a computation result in the storage unit. The control unit reads the computation result stored in the storage unit and outputs the computation result through the output unit. Various types of processing and steps are executed in this manner. The various types of processing are executed by the units and means. The computer may be a computer including a processor and memory storing a program, and the elements may implement various functions and various steps. The computer or the processor may be improved in the accuracy of the various types of processing through machine learning or deep learning. In this case, the accuracy of the machine learning or the deep learning can be improved by training a learning model using given data.

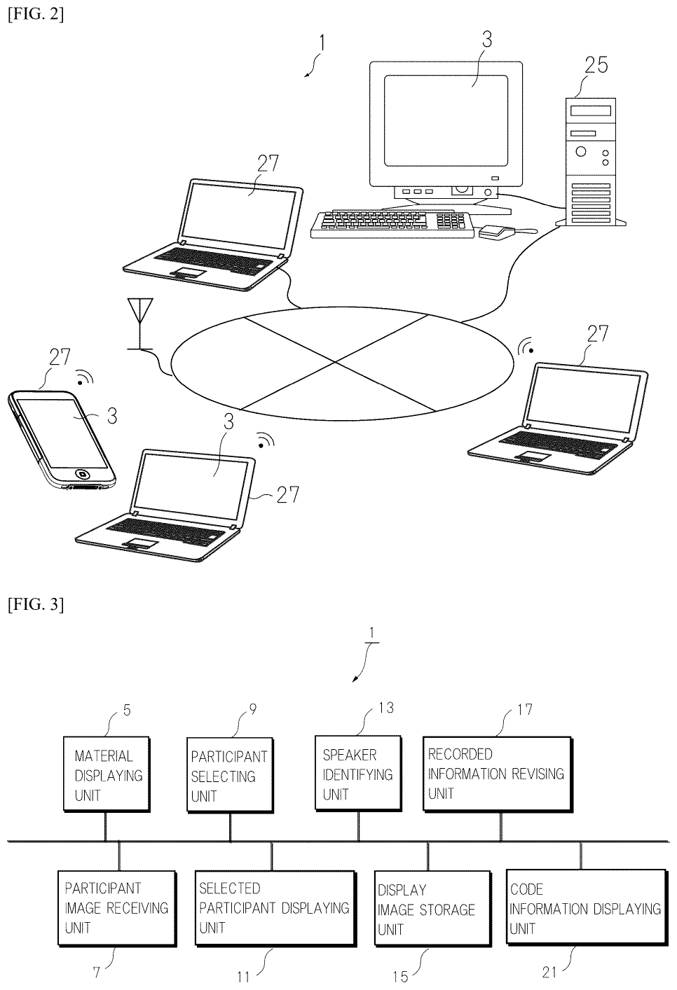

FIG. 2 is an overview diagram illustrating a web conferencing system. In an example illustrated in FIG. 2, a server 25 and a plurality of terminals (clients) 27 are connected together through a network (an intranet or the Internet). A web conferencing system 1 is a system for holding a web conference with the plurality of terminals connected to the system. A program for the web conferencing system may be installed on each terminal, or the program for the web conferencing system may be installed on the server.

FIG. 3 is a block diagram illustrating the web conferencing system. As illustrated in FIG. 3, the web conferencing system 1 includes a material displaying unit 5, a participant image receiving unit 7, a participant selecting unit 9, and a selected participant displaying unit 11. In addition, as illustrated in FIG. 3, this system 1 may further include any one or more of a speaker identifying unit 13, a display image storage unit 15, and a recorded information revising unit 17. In addition, as illustrated in FIG. 3, this method may include a code information displaying unit 21.

The material displaying unit 5 is an element that displays a material used for a web conference on display units 3. The participant image receiving unit 7 is an element that receives a captured image of each of a plurality of participants participating in the web conference. The participant selecting unit 9 is an element that receives the selection of two or more participants from among the participants received by the participant image receiving element. The selected participant displaying unit 11 is an element, for the web conferencing system 1, that extracts image regions of the participants for the two or more participants selected by the participant selecting element from captured images of the participants and displays images based on the extracted image regions of the participants together with a material on the display units 3. The selected participant displaying unit 11 displays the images based on the image regions of the participants on the basis of a predetermined display pattern on the display units 3. The units may be interpreted as means. The units perform the respective steps.

The material displaying step (S110) is a step of, by the web conferencing system 1, displaying the material used for the web conference on the display units 3. The display units 3 may be a display unit (a monitor, etc.) of the server or display units (monitors, etc.) of the terminals. The display unit of the server and the display units of the terminals may display an image based on the same information or may display images based on different pieces of information. A web conferencing system is a system that allows a plurality of terminals to meet simultaneously through a network (the Internet or an intranet). The web conferencing system itself is known. Examples of the web conferencing system include ZOOM®, Teams®, Meet®, WebEX®, Skype®, and LINE® meetings. For example, assume that a plurality of persons participate in a certain web conference. Then, a certain narrator (presenter) intends to share a certain material. Then, for example, a client computer of the narrator receives an instruction to read the material and reads the material from the storage unit. The client may be a personal computer (PC) or may be a portable terminal such as a smartphone. The client then outputs the read material to the system together with a sharing instruction. Receiving the sharing instruction and the material, the system displays the material on a display unit of the system. In addition, the system outputs information used for displaying the material to display units of clients of participants participating in the web conference. Examples of the material include a presentation material and various materials to be shared among the participants. Simultaneously with the material displaying step (S110) or after the material displaying step (S110), the code information displaying step (S210) described later may be performed.

The participant image receiving step (S120) is a step of, by the web conferencing system 1, receiving a captured image of each of a plurality of participants participating in the web conference. Note that, in this step, it is not necessary to receive captured images of all of the plurality of participants participating in the web conference. That is, because there may be a person who keeps a camera turned off in the web conference, a captured image of such a person is not necessary. For example, an image capturing unit (a camera) 23 of a client of each participant may capture an image of the photographer, and the captured image may be transmitted to the system 1. In such a manner, the web conferencing system 1 can receive the captured image of each of the plurality of participants participating in the web conference. In the web conference, when a participant turns on a camera, the camera captures an image of the participant and transmits the image to the web conferencing system. The web conferencing system then shares a video (including a sequence of images) of the person whose camera is turned on. Therefore, a typical web conferencing system can receive a captured image of each of a plurality of participants participating in a web conference. Captured images of participants may be stored in advance in the storage unit of the system 1, and when the system 1 receives information about a participant, the system 1 may read a captured image of the participant from the storage unit.

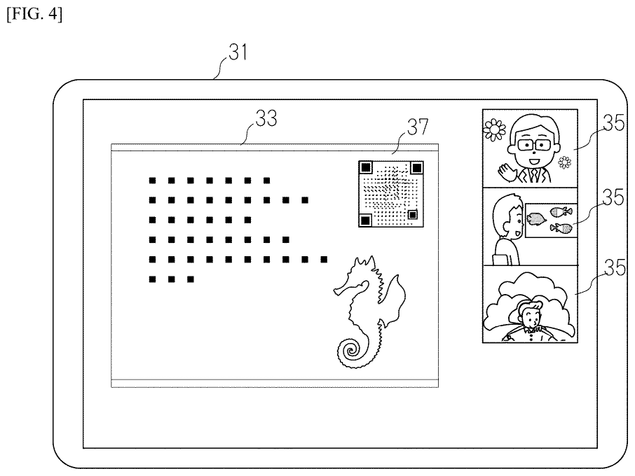

FIG. 4 is a conceptual diagram illustrating an example in which a material and participant images are displayed on a manager screen. In this example, a manager screen 31 displays an image 33 pertaining to the material and displays captured images 35 of participants. In this example, the manager screen 31 also displays code information 37. This code information 37 may be displayed on display units of terminals of the participants other than a manager. For example, the system 1 stores information on the displayed material and the participants in relation to this code information 37. Then, by using this code information, a participant can restore the information on the material and the participants, or a display screen.

The participant selecting step (S130) is a step of, by the web conferencing system 1, receiving the selection of two or more participants from among the participants whose images have been received in the participant image receiving step. For example, the narrator or the manager designates two or more persons from among the participants whose images are displayed on the display units. The system may then receive the selection of one, or two or more participants from among the participants whose images have been received in the participant image receiving step. This step may be automatically performed by the system or may be performed on the basis of an input from the server or a terminal. Examples of automatically performing this step by the server include an example described later and an example in which two or more participants are selected at random from among the participants. Note that, in an example, two or more participants are selected. However, one participant may be selected.

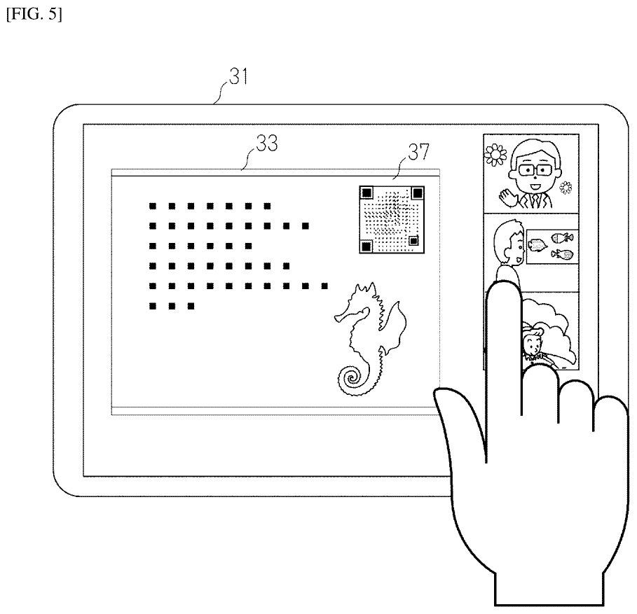

FIG. 5 is a diagram illustrating how the manager selects a participant. In this example, a display unit of a terminal of the manager serves as a participant management screen, on which the plurality of participants are displayed. The manager selects a captured image of the participant with a finger. Then, the system receives an input made with the finger and performs processing as if the participant is selected. Alternatively, the system may select the participant by designating the participant with a mouse or a voice. For example, the storage unit stores participant names in relation to participant information items (e.g., IDs of the participants). The system analyzes an input voice, determines a person's name, and stores the person's name in the storage unit as appropriate. The system then reads the stored person's name (a person's name included in the input voice) and the stored participant names and performs a comparing operation on the person's name and the participant names. As a result, the system finds a participant name that matches the stored person's name. Using information on the matching participant name found in such a manner, the system reads information about a participant having the participant name stored in the storage unit and can thus select the participant. With this configuration, for example, when a chairperson simply calls a participant name, a participant is selected, and an image relating to the participant is displayed on the display screen.

The participant selecting step (S130) may include the speaker identifying step (S131). The speaker identifying step (S131) is a step of, by the web conferencing system 1, identifying a person who has spoken, out of the participants participating in the web conference. For example, assume that two or more participants speak consecutively. In this case, voices are input into clients of the participants. The voices input into the clients are then transmitted to the system together with client information items (information items on the participants). The system then receives the voices input into the clients and the client information items (the information items on the participants). The system stores the received voices input into the clients and the received client information items (the information items on the participants) in the storage unit. In this manner, the system can identify a person who has spoken out of the participants participating in the web conference. Then, in the participant selecting step (S130), participants are selected using information about identified persons who have spoken. The system reads the client information items (the information items on the participants) stored in the storage unit and selects a plurality of participants, using the read client information items (the information items on the participants). At this time, for example, the two or more participants who have spoken consecutively may be selected.

In a preferable example of this screen composing method, in the case where the web conferencing system 1 determines that a first participant and a second participant have talked with each other, an image based on an image region of the first participant and an image based on an image region of the second participant may be displayed on the display units 3 in the selected participant displaying step (S130). The system 1 analyzes terminals into which voices have been input. In the case where voices of a predetermined number of persons have been input during a certain time period, the system 1 determines that the first participant and the second participant have talked. In such a manner, the system may display the image based on the image region of the first participant and the image based on the image region of the second participant on the display units 3.

In a preferable example of this screen composing method, in the case where the web conferencing system 1 determines that a questioner has asked a question about an explanation by a presenter, the web conferencing system 1 displays an image based on a video region of the presenter and an image based on a video region of the questioner on the display units 3 in the selected participant displaying step (S130).

The selected participant displaying step (S140) is a step of, by the web conferencing system 1, extracting an image region of each of the two or more participants selected in the participant selecting step from a captured image of the participant and displaying images based on the extracted image regions of the participants together with a material on the display units 3. The material in this case may be the material displayed on the display units (a certain page of a certain material or a certain part of the certain material). In the selected participant displaying step, the images based on the image regions of the participants are displayed on the basis of a predetermined display pattern on the display units 3. An example of the predetermined display pattern is displaying captured images directly. Another example of the predetermined display pattern is displaying only images based on the image regions of the participants on the display units. In a typical web conference, captured images of the participants are displayed directly (or with their backgrounds coordinated) on the display units. In this example, only the images based on the image regions of the participants are displayed on the display units. Then, it is possible to perform a display that looks as if the selected participants are having a discussion.

An example of the images based on the image regions of the participants may be captured images that are captured by terminals of the participants and from which their background parts are removed. An example of the images based on the image regions of the participants may be images of face parts of the participants that are extracted from the captured images captured by the terminals of the participants. The images may be those obtained by extracting the image regions of the participants from the captured images captured by the terminals of the participants and then performing predetermined processing on the image regions. An example of the predetermined processing is such processing that makes face regions of the participants look larger compared to their body regions, controls the opening and closing of a mouth of a participant at a predetermined frequency or in accordance with the participant's speech, or opens and closes the eyes of participants at a predetermined frequency. Such images can be obtained by storing a program for performing the image processing in the storage unit, reading the program under an instruction from the control unit, and causing the computation unit to perform a predetermined operation.

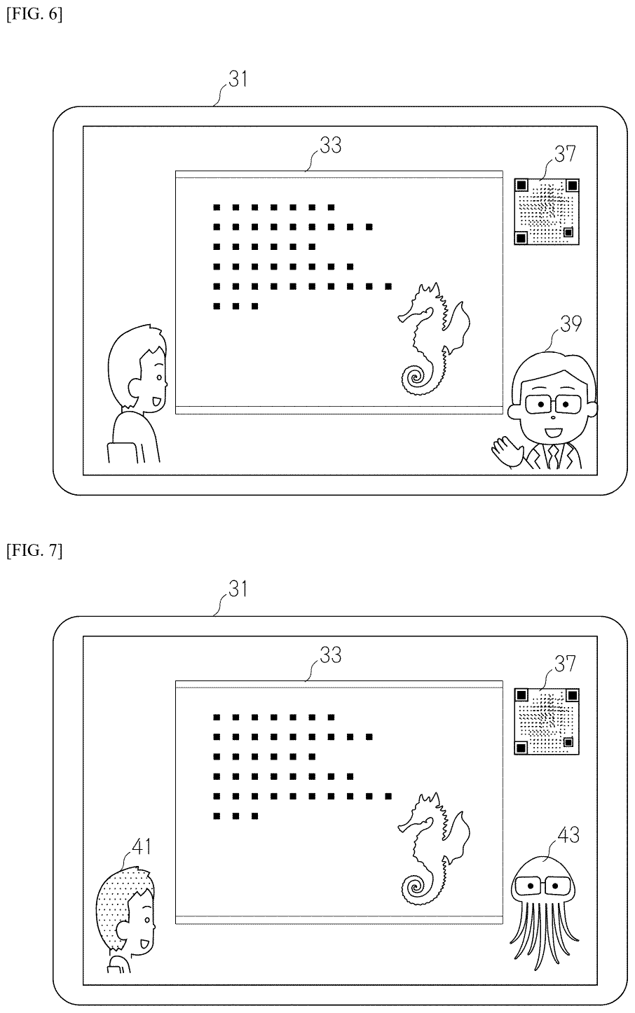

FIG. 6 is a diagram illustrating an example in which images based on image regions of participants are displayed. In FIG. 6, participants displayed at the top and the middle of the manager screen are selected, and images based on image regions of the participants (the images with their backgrounds removed) 39 are extracted by image processing and displayed on the right and left of the screen. In this manner, it is possible to perform a display that looks as if two participants are having a discussion or a debate about the image 33 pertaining to the material.

In another aspect of the selected participant displaying step (S140), the web conferencing system 1 displays images relating to one, or two or more participants selected in the participant selecting step on the display units 3. For example, the system 1 stores avatars relating to participants in the storage unit. On the basis of information about the one, or two or more participants selected in the participant selecting step, the system 1 reads one, or two or more avatars corresponding to the one, or two or more participants from the storage unit. The system 1 may thereafter control the read one, or two or more avatars as appropriate to perform a display that looks as if the one, or two or more avatars of the one, or two or more participants are speaking or having a conversation.

FIG. 7 is a diagram illustrating an example in which images based on image regions of participants are displayed. In this example, an exaggerated image 41, which is an image of the participant displayed at the middle of the manager screen with the color of the hair of the participant changed and with the face part of the participant enlarged, is displayed. In this example, avatar information on the participant displayed at the top of the manager screen is read from the storage unit, and avatar 43 corresponding to the participant is displayed on the screen. In this manner, this system may display a participant in an exaggerating manner or in the form of an avatar. By designing the display in such a manner, it is possible to attract the attention of viewers.

A preferable example of this screen composing method further includes the display image storing step (S150).

The display image storing step (S150) is a step of, by the web conferencing system 1, storing a display image including the material and the images based on the image regions of the participants displayed on the display unit 3 in the selected participant displaying step (S140). With the display image storing step, it is possible for a participant or a third person to obtain in the future an image that has been displayed on the display units. At this time, a voice at the time when a predetermined image is displayed may be additionally stored in the storage unit. The participant or the third person can play back the voice and the display image that has been displayed on the display units. Note that, at this time, code information described later may be displayed on the display units, and a display screen may be played back on the basis of the code information.

A preferable example of this screen composing method further includes the recorded information revising step (S160).

The recorded information revising step (S160) is a step of revising an image pertaining to the material in the display image stored in the display image storing step (S150) and storing the revised image in the case where the material has been revised. The storage unit of the system 1 stores information about a page or a part of the material displayed on the display units in relation to the display image. Receiving information indicating that the displayed page or part of the material has been revised, the system 1 replaces information on the page or part of the material in the display image stored in the storage unit with information on the revised page or part and stores the display image after the revision as a revised display image in the storage unit. Then, in the case where a participant or a third person intends to obtain a display image in the future, the participant or the third person can obtain the revised image. Therefore, for example, it is possible to provide a display image with up-to-date information in the case where a provided lecture contains a mistake, in the case where information has been changed due to the revision of a law, in the case where a system has been changed, or the like. By additionally revising voice data stored in the storage unit in accordance with the above, it becomes possible to provide the display image together with an updated speech to the participant or the third person. Furthermore, in the case where one of the participants displayed on the screen wants to stop being displayed in the future, it is possible to continue to provide trouble-free video information without losing its content in itself by reading an image or an avatar of another participant using information about the other participant (e.g., identification information on the other participant) and replacing an image of the participant who wants to stop being displayed with the image or the avatar of the other participant.

In an example of the screen composing method, the web conferencing system 1 includes the code information displaying step (S210). The code information displaying step (S210) is a step of displaying the code information on the display units 3. For example, in the code information displaying step (S210), code information corresponding to each page of the material is displayed on the display units 3. In a preferable example of this step, as the web conference progresses, the web conferencing system 1 updates the code information to obtain updated code information and displays the updated code information on the display units 3. This code information is stored in the storage unit of the system 1 in relation to the material displayed on the display units. Therefore, by referring to this code information, the participant or the third person can obtain the material. In addition, as described above, for example, the storage unit stores, in relation to the code information, a page or a part of the material and additionally voice data at the time when the page or the part is displayed. In this example, referring to the code information makes it possible to obtain not only the page or the part of the material but also the voice at the time when the page or the part is displayed.

The following invention relates to a program and a non-transitory computer-readable information recording medium that stores the program. This program is a program for causing a computer to execute any one of the screen composing methods described above.

### INDUSTRIAL APPLICABILITY

This method can be used for a web conferencing system and the like.

### REFERENCE SIGNS LIST

1 web conferencing system
5 material display unit
7 participant image receiving unit
9 participant selecting unit
11 selected participant displaying unit
13 speaker identifying unit
15 display image storage unit
17 recorded information revising unit
21 code information displaying unit

1. A screen composing method using a web conferencing system, the screen composing method comprising:
a material displaying step of, by the web conference system, displaying a material used for a web conference on a display unit;
a participant image receiving step of, by the web conferencing system, receiving a captured image of each of a plurality of participants participating in the web conference;
a participant selecting step of, by the web conferencing system, receiving a selection of two or more participants from among the participants whose images images have been received in the participant image receiving step; and
a selected participant displaying step of, by the web conferencing system, extracting image regions of the participants for the two or more participants selected in the participant selecting step from captured images of the participants and displaying images based on the extracted image regions of the participants together with the material on the display unit,
the images based on the image regions of the participants being images of face parts of the participants, the face parts being extracted from the captured images of the participants,
the images based on the image regions of the participants being displayed on the display unit on a basis of a predetermined display pattern in the selected participant displaying step, wherein
the participants participating in the web conference include a first participant and a second participant, and
when the first participant and the second participant are determined to have talked with each other, the web conferencing system displays an image based on an image region of the first participant and an image based on an image region of the second participant on the display unit in the selected participant displaying step.

2. The screen composing method using the web conferencing system according to claim 1, further comprising
a speaker identifying step of, by the web conferencing system, identifying a person who has spoken, out of the participants participating in the web conferencing, wherein
the participant selecting step further includes a step of selecting two or more participants from among the participants, using information about the identified person who has spoken.

3. The screen composing method using the web conferencing system according to claim 1, wherein
the first participant and the second participant include a presenter and a questioner, and
when the questioner is determined to have asked a question about an explanation by the presenter, the web conferencing system displays an image of a video region of the presenter and an image based on a video region of the questioner on the display unit in the selected participant displaying step.

4. The screen composing method using the web conferencing system according to claim 1, further comprising a display image storing step of, by the web conferencing system, storing a display image including the material and the images based on the image regions of the participants displayed on the display unit in the selected participant displaying step.

5. The screen composing method using the web conferencing system according to claim 4, further comprising a recorded information revising step of revising an image pertaining to the material in the display image stored in the display image storing step and storing the revised image in a case where the material has been revised.

6. The screen composing method using the web conferencing system according to claim 1, further comprising a code information displaying step of, by the web conferencing system, displaying code information on the display unit.

7. The screen composing method using the web conferencing system according to claim 6, wherein the material includes a plurality of pages, and in the code information displaying step, for each page displayed on the display unit, code information corresponding to the page is displayed on the display unit.

8. The screen composing method using the web conferencing system according to claim 6, wherein as the web conference progresses, the web conferencing system updates the code information to obtain updated code information, and the web conferencing system displays the updated code information on the display unit.

9. A program for causing a computer to execute a screen composing method using a web conferencing system, the screen composing method comprising:
a material displaying step of, by the web conference system, displaying a material used for a web conference on a display unit;
a participant image receiving step of, by the web conferencing system, receiving a captured image of each of a plurality of participants participating in the web conference;
a participant selecting step of, by the web conferencing system, receiving selection of two or more participants from among the participants whose images have been received in the participant image receiving step; and
a selected participant displaying step of, by the web conferencing system, extracting image regions of the participants for the two or more participants selected in the participant selecting step from captured images of the participants and displaying images based on the extracted image regions of the participants together with the material on the display unit,
the images based on the image regions of the participants being images of face parts of the participants, the face parts being extracted from the captured images of the participants,
the images based on the image regions of the participants being displayed on the display unit on a basis of a predetermined display pattern in the selected participant displaying step, wherein
the participants participating in the web conference include a first participant and a second participant, and
when the first participant and the second participant are determined to have talked with each other, the web conferencing system displays an image based on an image region of the first participant and an image based on an image region of the second participant on the display unit in the selected participant displaying step.

10. A non-transitory computer-readable information recording medium storing the program according to claim 9.
